(19) United States
(12) Patent Application Publication
(10) Pub. No.: US 2025/0328026 A1
(43) Pub. Date: Oct. 23, 2025

(54) LENS ASSEMBLY, PROCESSING METHOD OF LENS ASSEMBLY AND DISPLAY DEVICE

(71) Applicants: Asphetek Solution (Chengdu) Ltd., Chengdu (CN); Asphetek Solution Inc., Hsinchu (TW)

(72) Inventors: CHENG-HONG JIANG, Hsinchu (TW); YEN-HENG HUANG, Hsinchu (TW)

(21) Appl. No.: 18/786,590

(22) Filed: Jul. 29, 2024

(30) Foreign Application Priority Data
Apr. 19, 2024 (CN) 202410478245.9

(51) Int. Cl. G02B 27/62; G01M 11/02; G02B 1/10

(52) U.S. Cl. CPC G02B 27/62; G01M 11/0221; G02B 1/10

(57) ABSTRACT

This disclosure provides a lens assembly, a processing method of lens assembly and a display device. The lens assembly comprising a lens and one or more film. The lens comprises an optical part, a connection part, and a plurality of detection units, each of the plurality of detection units comprises two detection parts, and a first virtual line is defined between the two detection parts, the first virtual lines of the plurality of detection units is intersected at an intersection point. The film comprises an optical film, one or more release film, and a nick, the optical film defines an optical axis, the nick is provided on a surface of the release film, projection of the nick on the optical film is coincided with the optical axis, two ends of the nick is corresponded to each of the two detection parts of a detection unit.

### FIELD

The disclosure relates to a technical field of display device, in particular to a lens assembly, a processing method of lens assembly and a display device.

### BACKGROUND

Existing lens assembly includes a lens and an optical film, the optical film being fixed on the lens. The optical film defines an optical axis, the optical axis of the optical film is not observable to eyes of a user, and an optical axis of the lens assemble are also not observable to the user. In process of assembling the lens assembly, inspection equipment is required to determine a position of the optical axis of the lens assembly, the inspection equipment is expensive, and makes processing and production of the lens assembly costly.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding portions throughout the several views.

FIG. 1 is a diagrammatic view of a lens assembly according to an embodiment of the present disclosure.

FIG. 2 is a cut-open view of a lens assembly device according to another embodiment of the present disclosure.

FIG. 3 is a diagrammatic view of a lens assembly according to an embodiment of the present disclosure.

FIG. 4 is a partial enlarged view of a portion marked A in FIG. 3.

FIG. 5 is a cut-open view of a film according to an embodiment of the present disclosure.

FIG. 6 is a diagrammatic view of a material according to an embodiment of the present disclosure.

FIG. 7 is a partial enlarged view of a portion marked B in FIG. 6.

FIG. 8 is a diagrammatic view of a display device according to an embodiment of the present disclosure.

FIG. 9 is a process flow diagram of a processing method of lens assembly according to an embodiment of the present disclosure.

### DESCRIPTION OF MAIN COMPONENTS OR ELEMENTS

lens assembly 100;
lens 10;
optical part 11;
connection part 12;
inner edge 121;
outer edge 122;
location part 123;
detection unit 20;
first detection unit 20a;
second detection unit 20b;
third detection unit 20c;
detection part 21;
detection line 22;
first detection line 22a;
second detection line 22b;
fan-shaped area 23;
sector center 231;
side edge 24;
first side edge 24a;
second side edge 24b;
film 30;
optical film 31;
release film 32;
first release film 321;
second release film 322;
nick 33;
location hole 34;
location edge 35;
first film 30a;
second film 30b;
third film 30c;
intersection point H;
first center of circle M1;
second center of circle M2;
optical axis N;
first optical axis N1;
second optical axis N2;
third optical axis N3;
fourth optical axis N4;
optical axis direction Z;
first virtual line L1;
second virtual line L2;
material 200;
cutting line 201;
display device 300;
frame 301.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

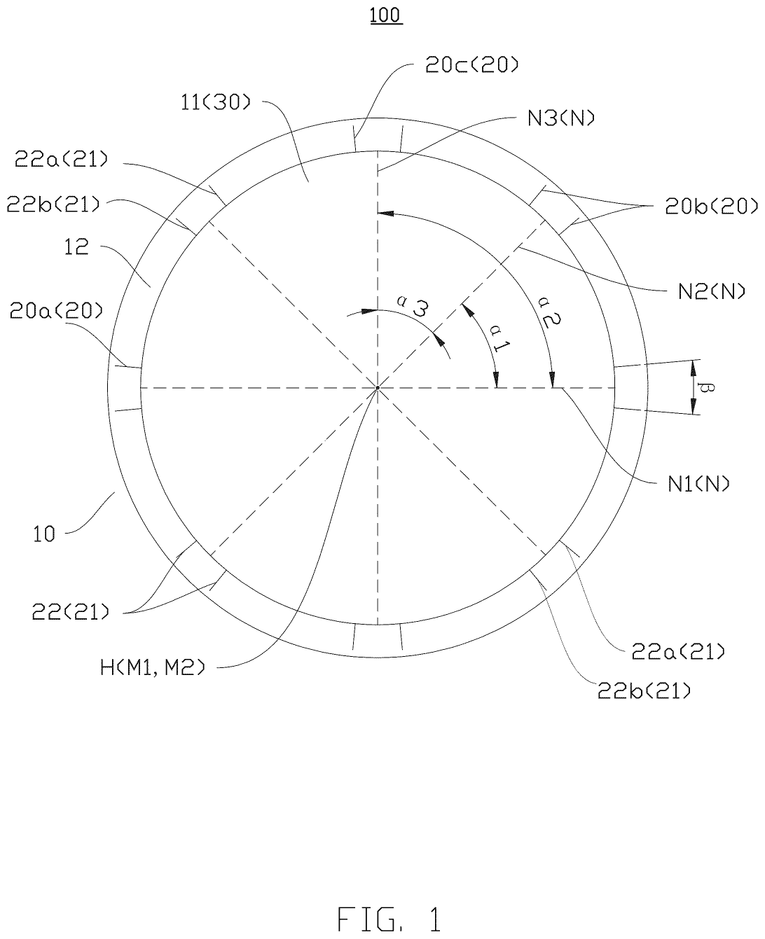

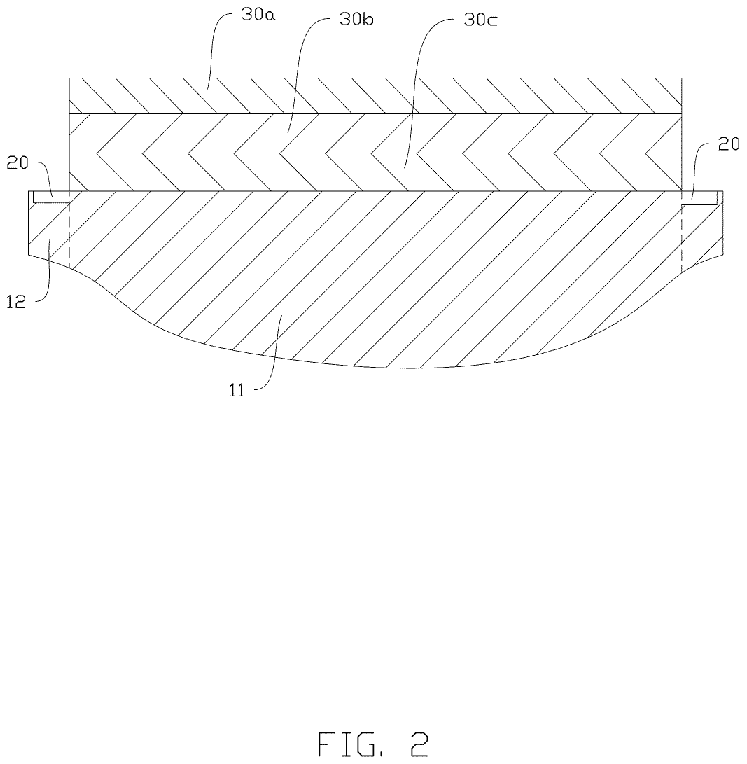

Referring to FIG. 1 and FIG. 2, in one embodiment, a lens assembly 100 is provided. The lens assembly 100 includes a lens 10 and one or more film 30. The lens 10 includes an optical part 11, a connection part 12 and a plurality of detection units 20. The connection part 12 is connected to an edge of the optical part 11. Each of the plurality of detection units 20 includes two detection parts 21, and a first virtual line L1 is defined between the two detection parts 21 defines, the first virtual lines L1 of the plurality of detection units 20 is intersected at an intersection point H. The film 30 includes an optical film 31, one or more release film 32 and a nick 33. The optical film 31 is arranged on the optical part 11. The optical film 31 defines an optical axis N. The release film 32 is arranged on one side of the optical film 31 away from the optical part 11. The nick 33 is provided on a surface of the release film 32, a projection of the nick 33 on the optical film 31 in a direction perpendicular to the optical film 31 is coincided with the optical axis N. One end of the nick 33 is corresponded to one of the two detection parts 21 of a detection unit 20, other end of the nick 33 is corresponded to another of the two detection parts 21 of the detection unit 20.

The nick 33 can make the optical axis N of the optical film 31 observable by operator in real time, and does not affect integrity of the optical film 31. During assembly of the film 30 on the optical section 11, each end of the nick 33 are provided in correspondence with the two detection parts 21 of one detection unit 20. After removing the release film 32, position of the optical axis N of the optical film 31 on the lens 10 can be determined by the two detection parts 21 of this detection unit 20.

In other assembling processes of assembling the lens assembly 100 in, such as attaching the film 30 on the lens 10 or cooperating one lens assembly 100 with other lens assembly 100, the detection units 20 corresponding to the indentation 33 can be used to quickly determine position of the optical axis N of the lens assembly 100, so that there is no need to use expensive optical measuring equipment to determine position of the optical axis N of the lens assembly 100, and ensure precision of the assembling of the lens assembly 100, and reduce production cost of the processing of the lens assembly 100.

In one embodiment, during assembly of the lens assembly 100, alignment detection time of the film 30 in the lens 10 can be as low as about 2 seconds. Furthermore, in the follow-up sampling inspection process, full inspection can also be achieved simply and reliably.

In one embodiment, the detection part 21 can be structures in shape of bright or foggy lines on the connection part 22. The structures are formed through a mold by a fine polishing process or nibbling process.

In one embodiment, referring to FIG. 1, the lens assembly 100 includes a plurality of films 30. Each of the plurality of films 30 is transparent. The plurality of the two films 30 are stacked, and the plurality of films 30 are provided on the lens 10. Two ends of each of the nick 33 are respectively provided in correspondence with the two detecting parts 21 of each of the detection units 20. The projection of the optical axis N of each of the optical film 31 on the lens 10 in a direction perpendicular to the lens 10 is intersected with each other at the intersection point H.

A virtual angle α is defined at two first virtual lines L1 of the two detection units 20, an optical angle θ is provided at two optical axis N of the two optical films 31 corresponding to the two detection units 20, and the virtual angle α is equal to the optical angle θ.

When setting position of the detection part 21 of the two detection units 20 in the connection part 12, the virtual angle of the two detection units 20 is formed to be the same as a desired optical angle. During assembly of the lens assembly 100, by aligning the nick 33 with the detection unit 20, the optical angle of the two optical films 31 can be ensured to be the desired optical angle. This improves accuracy of assembling process of the film 30, and improved efficiency of the processing, accuracy of the processing of the lens assembly 100, and reduce cost of the lens assembly 100.

In one embodiment, referring to FIG. 2, three films 30 and three detection units 20 are provided. Each of the three films 30 includes a first film 30a, a second film 30b and a third film 30c. The first film 30a, the second film 30b and the third film 30c are stacked. The first film 30a, the second film 30b and the third film 30c are provided on the optical portion 11. Each of the three detection units 20 includes a first detection unit 20a, a second detection unit 20b and a third detection unit 20c.

Referring to FIG. 1, the first film 30a defines a first optical axis N1, the second film 30b defines a second optical axis N2, and the third film 30c defines a third optical axis N3. The first optical axis N1, the second optical axis N2, and the third optical axis N3 are intersected at the intersection point H. A projection of the first optical axis N1 on the lens 10 in a direction perpendicular to the lens 10 is coincided with the first detection unit 20a, a projection of the second optical axis N2 on the lens 10 in a direction perpendicular to the lens 10 is coincided with the second detection unit 20b, a projection of the third optical axis N3 on the lens 10 in a direction perpendicular to the lens 10 is coincided with the third detection unit 20c.

A first optical angle is defined between the first optical axis N1 and the second optical axis N2, a second optical angle is defined between the first optical axis N1 and the third optical axis N3, a third optical angle is defined between the second optical axis N2 and the third optical axis N3. A first virtual angle is defined between the first optical axis N1 and the second optical axis N2. A second virtual angle is defined between the first optical axis N1 and the third optical axis N3. A third virtual angle is defined between the third optical axis N3 and the second optical axis N2. The first optical angle and the first virtual angle are equal to α1, the second optical angle and the second virtual angle are equal to α2, and the third optical angle and the third virtual angle are equal to α3.

In one embodiment, α1=45°, α2=90°, α3=45°.

In other embodiment, the lens assembly 100 includes two detection units 20, or four detection units 20, or more than four detection units 20.

In one embodiment, the optical part 11 defines a fourth optical axis N4, the connection part 12 defines two location parts 123, the two location parts 123 are spaced apart in the connection part 12. A second virtual line L2 is defined between the two location parts 123, the second virtual line L2 passes through the intersection point H, and line connecting the two location parts 123 coincides with the fourth optical axis N4.

A position of the fourth optical axis N4 can be determined based on positions of two location parts 123. When the film 30 is fitted on the lens 10, the angle between the optical axis N and the fourth optical axis N4 can be adjusted by setting the film 30 corresponding to the different detection unit 20.

The two location parts may be machined in a same manner as the detection part 21.

In one embodiment, referring to FIG. 1, each of the plurality of detection units 20 includes two detection lines 22. One end of the nick 33 is arranged between two detection lines 22 of one of the two detection parts 21, another end of the nick 33 is arranged between two detection lines 22 of another of the two detection parts 21.

By controlling the nick 33 to be located between the two detection lines 22, can improves accuracy of correspondence between the nick 33 and the detection portion 21, and improves accuracy of position of the film 30 on the lens 10, and improves accuracy of assembly of the lens assembly 100.

In one embodiment, angle of the two detection lines 22 is β, 0≤β≤10°, β can be 0°, 1°, 2°, 3°, 4°, 5°, 6°, 7°, 8°, 9° or 10°.

In one embodiment, extended lines of the two detection lines 22 pass through the intersection point H. When laminating the film 30 to the lens 10, the nick 33 is controlled to be coincided with the detection line 22 to assemble the film 30 on the lens 10.

In one embodiment, the detection part 21 may include a plurality of detection lines 22, and each extended line of the plurality of detection lines 22 passes through the intersection point H.

There are various ways to arrange the nick 33 over the detection part 21.

For example, referring to FIG. 1, the detection part 21 includes a first detection line 22a and a second detection line 22b, extended line of the first detection line 22a of one detection part 21 of one detection unit 20 is coincided with the second detection line 22b of other detection part 21 of the detection unit 20. When laminating the film 30 to the lens 10, one end of the nick 33 is controlled to be coincided with the first detection line 22a of one detection part 21 of one detection unit 20, and control other end of the nick 33 coincides with the second detection line 22b of other detection part 21. Therefore, position of the optical axis N on the lens 10 is accuracy by the first detection line 22a and the second detection line 22b.

When β is small, such as 0<β<1°, a projection of one end of the nick 33 on the lens 10 in a direction perpendicular to the lens 10 is between the two detection lines 22 of one detection part 21, and a projection of other end of the nick 33 on the lens 10 in a direction perpendicular to the lens 10 is between the two detection lines 22 of other detection part 21.

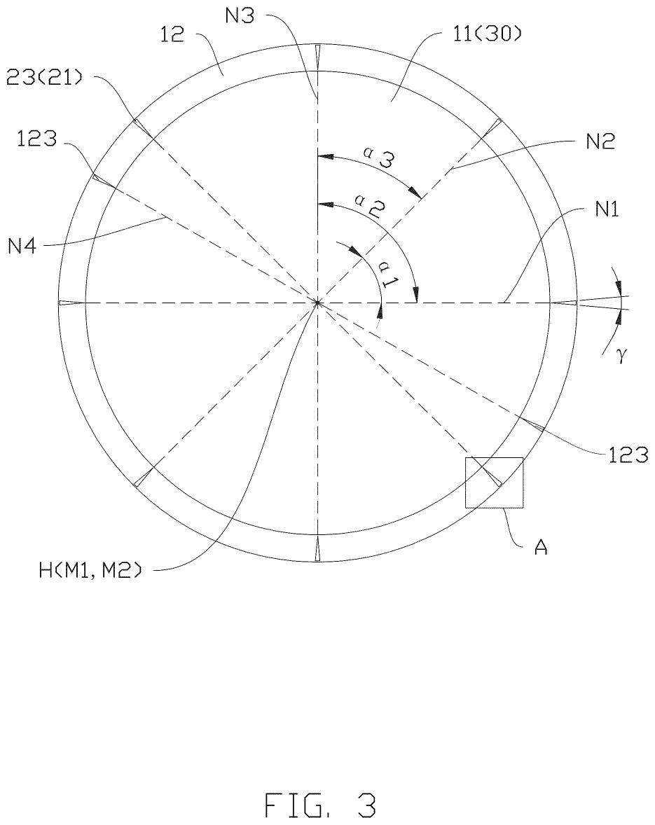

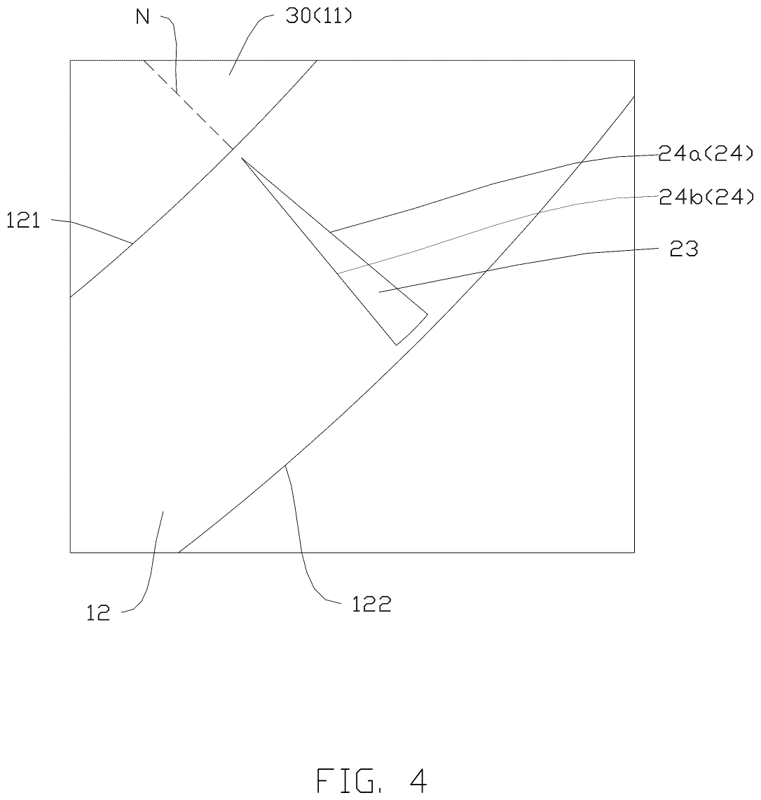

In one embodiment, referring to FIG. 3 and FIG. 4, the connection part 12 defines an inner edge 121 and an outer edge 122.

In other embodiment, referring to FIG. 3 and FIG. 4, the detection part 21 is a fan-shaped area 23, the fan-shaped area 23 is on a surface of the connection part 12. The two detection lines 22 are two side edges 24 of the fan-shaped area 23. The fan-shaped area 23 defines a sector center of a circle, the sector center of the circle is between the inner edge 121 and the outer edge 122. The two side edges 24 intersects at the sector center of the circle.

There are various ways to arrange the nick 33 over the detection part 21.

For example, the fan-shaped area 23 includes a first side edge 24a and a second side edge 24b. Extended line of the first side edge 24a of one fan-shaped area 23 is coincided with the second side edge 24b of other fan-shaped area 23. When laminating the film 30 to the lens 10, one end of the nick 33 is coincided with the first side edge 24a of one fan-shaped area 23, and another end of the nick 33 is coincided with the second side edge 24b of other fan-shaped area 23. Therefore, position of the optical axis N on the lens 10 is accuracy by the first side edge 24a and the second side edge 24b.

In one embodiment, referring to FIG. 2, the lens 10 defines a circular cross-section, the lens 10 defines a first center of circle M1. The intersection point H coincides with the first center of circle M1. The optical film 31 has a circular cross-section, the optical film 31 defines a second center of circle M2. A projection of the second center of the circle M2 on the lens 10 in a direction perpendicular to the lens 10 coincides with the first center of the circle M1.

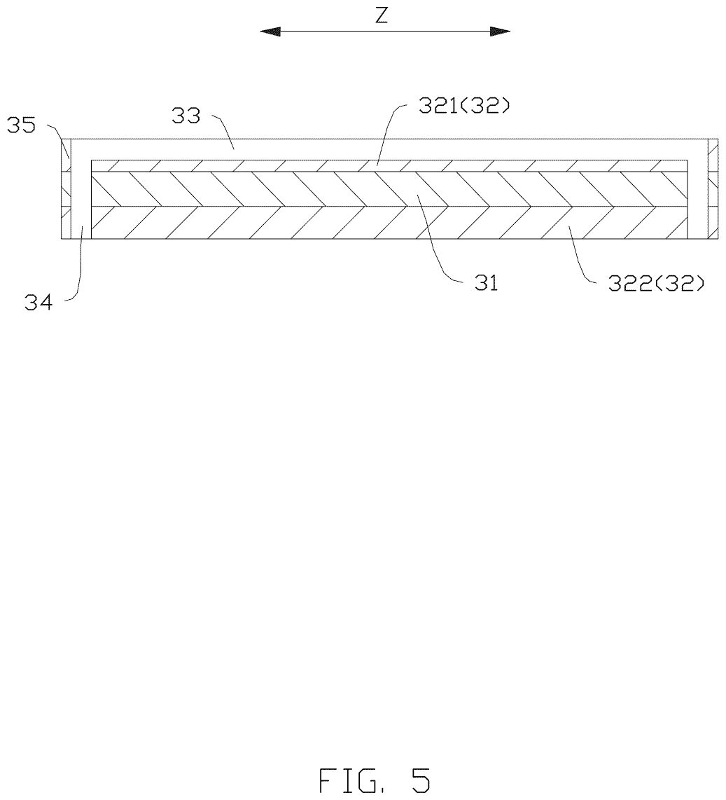

In one embodiment, referring to FIG. 5 to FIG. 7, the film 30 defines a location edge 35, two location holes 34 are provided on the location edge 35 of the film 30. The two location holes 34 penetrates through the optical film 31 and the release film 32. The two location holes 34 are respectively provided at each end of the nick 33.

During assembly of the plurality of films 30, position of the above described film 30 on the latter film 30 may be positioned by cooperation of the location holes 34 with the detection part 21, and improve assembly efficiency and judged reliability of the lens assembly 100.

In one embodiment, referring to FIG. 5, the nick 33 is an elongated groove on the surface of the release film 32.

In one embodiment, referring to FIG. 5, the film 30 includes a first release film 321 and a second release film 322. The first release film 321 is arranged on one surface of the optical film 31, the second release film 322 is arranged on other surface of the optical film 31. The nick 33 is provided on a surface of the first release film 321. A color of the optical film 31, a color of the first release film 321, and a color of the second release film 322 are different from each other. In one embodiment, a diameter of each of the location holes 34 is between 30 μm to 200 μm.

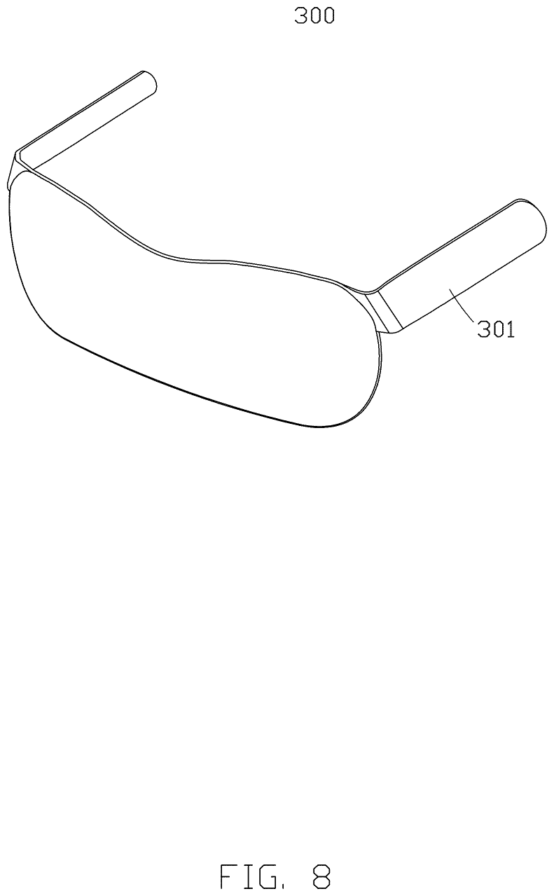

Referring to FIG. 8, in one embodiment, a display device 300 is provided. The display device 300 includes a frame 301 and the lens assembly 100. The lens assembly 100 is arranged in the frame 301.

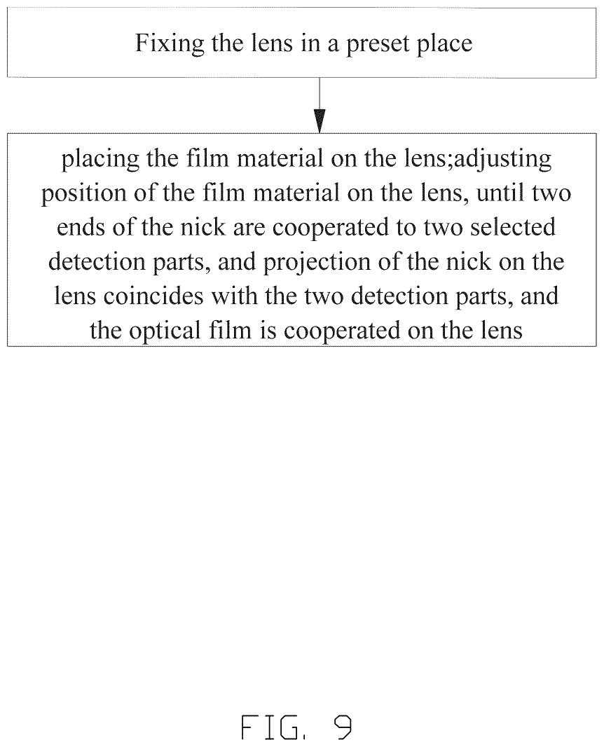

Referring to FIG. 9, in one embodiment, a processing method of lens assembly is provided. The processing method of lens assembly for positioning and mounting the on the lens 10.

The processing method of lens assembly includes: fixing the lens 10 in a preset place; placing the film 30 on the lens 10; adjusting a position of the film 30 on the lens 10, until two ends of the nick 33 are correspond to two selected detection parts 21, and a projection of the nick 33 on the lens 10 in a direction perpendicular to the lens 10 coincides with the two detection parts 21, and the optical film 31 is accommodated on the lens 10.

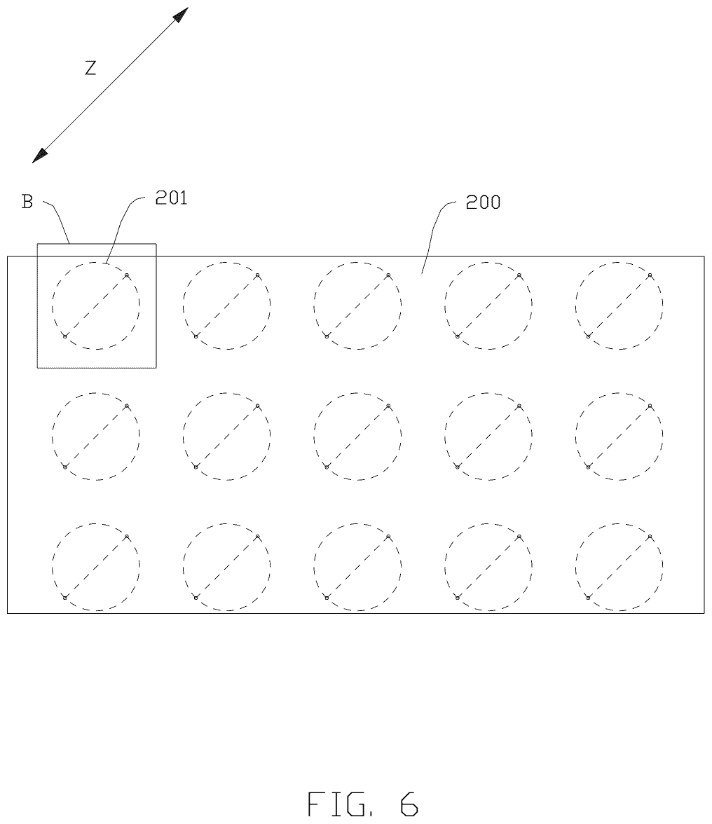

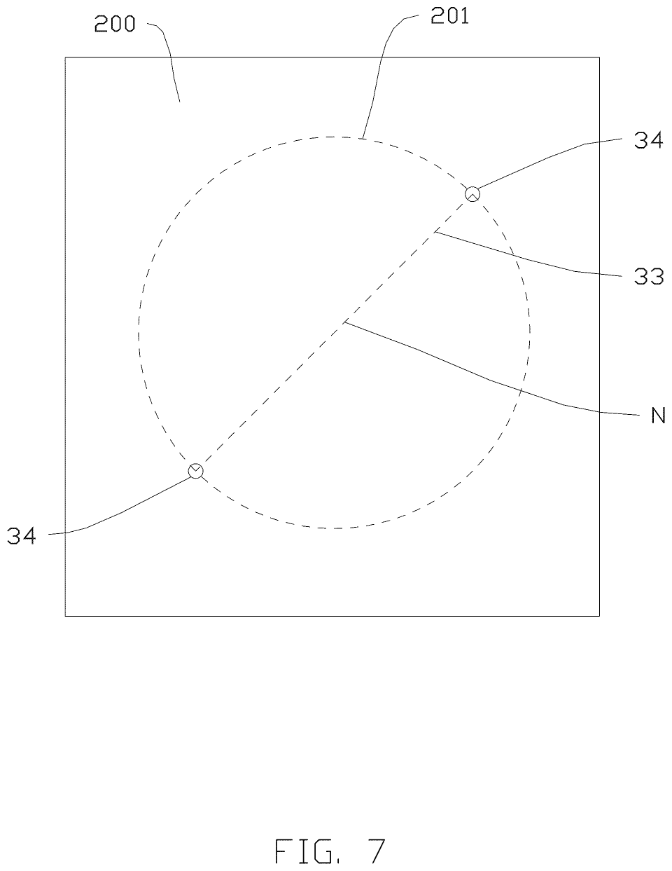

In one embodiment, referring to FIG. 6 and FIG. 7, the processing method of lens assembly further includes: processing the plurality of detection units 20 on the lens 10; providing a webbing 200, the webbing 200 further defines a plurality of cutting lines 201, the plurality of cutting lines 201 is spaced apart from each other. The webbing 200 defines an optical axis direction Z. Processing a nick 33 in each of the plurality of cutting lines 201. A length direction of the nick 33 is parallel to the optical axis direction Z. Cutting the plurality of cutting lines 201 and obtaining a plurality of films 30.

What is claimed is:

1. A lens assembly comprising:
a lens comprising an optical part, a connection part, and a plurality of detection units, wherein the connection part is connected to an edge of the optical part, each of the plurality of detection units comprises two detection parts, and a first virtual line is defined between the two detection parts, the first virtual lines of the plurality of detection units intersect at an intersection point; and
one or more film comprising an optical film, one or more release film, and a nick, wherein the optical film is arranged on the optical part of the lens, the optical film defines an optical axis, the release film is arranged on one side of the optical film away from the optical part, the nick is provided on a surface of the release film, a projection of the nick on the optical film in a direction perpendicular to the optical film coincides with the optical axis, one end of the nick corresponds to one of the two detection parts of a detection unit, another end of the nick corresponds to another one of the two detection parts of the detection unit.

2. The lens assembly as claimed in claim 1 comprising a plurality of films, wherein each of the plurality of films is transparent, the plurality of films is stacked, and the plurality of films is provided on the lens, two ends of each nick of the plurality of films are respectively provided corresponding to the two detecting parts of each of the plurality of detection units.

3. The lens assembly as claimed in claim 1, wherein each of the plurality of detection units comprises two detection lines, one end of the nick is arranged between the two detection lines of one of the two detection parts, another end of the nick is arranged between the two detection lines of another one of the two detection parts.

4. The lens assembly as claimed in claim 3, wherein extended lines of the two detection lines pass through the intersection point.

5. The lens assembly as claimed in claim 3, wherein the connection part defines an inner edge and an outer edge; the detection part is a fan-shaped area, the fan-shaped area is on a surface of the connection part, the two detection lines are two side edges of the fan-shaped area, the fan-shaped area defines a sector center of a circle, the sector center of the circle is between the inner edge and the outer edge, the two side edges intersects at the sector center of the circle.

6. The lens assembly as claimed in claim 1, wherein the film defines a location edge, two location holes are provided on the location edge, the two location holes penetrate through the optical film and the release film, the two location holes are respectively provided at each end the nick.

7. The lens assembly as claimed in claim 6, wherein a diameter of each of the two location holes is between 30 μm to 200 μm.

8. The lens assembly as claimed in claim 1, wherein the lens defines a first center of a circle, the intersection point coincides with the first center of the circle;
the optical film defines a second center of a circle, a projection of the second center of the circle on the lens in along a direction perpendicular to the lens coincides with the first center of the circle.

9. The lens assembly as claimed in claim 1, wherein the film comprises a first release film and a second release film, the first release film is arranged on one surface of the optical film, the second release film is arranged on another surface of the optical film, the nick is provided on a surface of the first release film; a color of the optical film, a color of the first release film, and a color of the second release film are different from each other.

10. The lens assembly as claimed in claim 1, wherein the optical part defines a fourth optical axis, the connection part defines two location parts, the two location parts are spaced apart in the connection part, a second virtual line is defined between the two location parts, the second virtual line passes through the intersection point, and a line connecting the two location parts coincides with the fourth optical axis.

11. The lens assembly as claimed in claim 1, wherein the nick is an elongated groove on the surface of the release film.

12. A processing method of lens assembly, the processing method of lens assembly comprises:
fixing the lens in a preset place;
placing a film on the lens, the film defines a nick;
adjusting a position of the film on the lens, until two ends of the nick are correspond to two selected detection parts, and a projection of the nick on the lens coincides with the two detection parts, and the optical film is accommodated on the lens.

13. The processing method of lens assembly as claimed in claim 12, wherein the processing method of lens assembly further comprises:
processing the plurality of detection units on the lens;
providing a webbing, wherein the webbing defines a plurality of cutting lines, the plurality of cutting lines is spaced apart from each other, the webbing further defines an optical axis direction, processing the nick in each of the plurality of cutting lines, a length direction of the nick is parallel to the optical axis direction, cut the plurality of cutting lines and obtaining a plurality of films.

14. A display device, comprising:
a frame; and
a lens assembly, wherein the lens assembly is arranged in the frame, the lens assembly further comprising:
a lens comprising an optical part, a connection part, and a plurality of detection units, wherein the connection part is connected to an edge of the optical part, each of the plurality of detection units comprises two detection parts, and a first virtual line is defined between the two detection parts, the first virtual lines of the plurality of detection units intersect at an intersection point; and
one or more film comprising an optical film, one or more release film, and a nick, wherein the optical film is arranged on the optical part of the lens, the optical film defines an optical axis, the release film is arranged on one side of the optical film away from the optical part, the nick is provided on a surface of the release film, a projection of the nick on the optical film in a direction perpendicular to the optical film coincides with the optical axis, one end of the nick corresponds to one of the two detection parts of a detection unit, another end of the nick corresponds to another one of the two detection parts of the detection unit.

15. The display device as claimed in claim 14, wherein each of the plurality of films is transparent, the plurality of films is stacked, and the plurality of films is provided on the lens, two ends of each nick of the plurality of films are respectively provided corresponding to the two detecting parts of each of the plurality of detection units.

16. The display device as claimed in claim 14, wherein each of the plurality of detection units comprises two detection lines, one end of the nick is arranged between the two detection lines of one of the two detection parts, another end of the nick is arranged between the two detection lines of another one of the two detection parts.

17. The display device as claimed in claim 16, wherein extended lines of the two detection lines pass through the intersection point.

18. The display device as claimed in claim 16, wherein the connection part defines an inner edge and an outer edge; the detection part is a fan-shaped area, the fan-shaped area is on a surface of the connection part, the two detection lines are two side edges of the fan-shaped area, the fan-shaped area defines a sector center of a circle, the sector center of the circle is between the inner edge and the outer edge, the two side edges intersects at the sector center of the circle.

19. The display device as claimed in claim 14, wherein the film defines a location edge, two location holes are provided on the location edge, the two location holes penetrate through the optical film and the release film, the two location holes are respectively provided at each end the nick.

20. The display device as claimed in claim 19, wherein a diameter of each of the two location holes is between 30 μm to 200 μm.
